(19) United States
(12) Patent Application Publication
(10) Pub. No.: US 2006/0180779 A1
(43) Pub. Date: Aug. 17, 2006

(54) Microfluidic valve

(76) Inventors: Brian Philip Allen, Essex (GB); Xiao Feng Zhou, Essex (GB); Richard Gilbert, Essex (GB)

Correspondence Address: HELLER EHRMAN WHITE & MCAULIFFE LLP, 1717 RHODE ISLAND AVE, NW, WASHINGTON, DC, 20036-3001, US

(21) Appl. No.: 10/567,428

(22) PCT Filed: Aug. 4, 2004
(86) PCT No.: PCT/GB04/03389

§ 371 Date: Mar. 20, 2006

(30) Foreign Application Priority Data
Aug. 5, 2003 (GB) 0318359.7

(51) Int. Cl. F16K 31/02

(52) U.S. Cl. 251/129.01

(57) ABSTRACT

The invention provides a microfluidic valve comprising a first body for containing fluid having a fluid inlet and a fluid outlet and a plurality of electrodes, and arranged to contain, in use, a second body held within fluid contained in the first body, the second body being moveable toward or away from one of the fluid inlet or fluid outlet, the movement of the second body caused by the electric field generated by the electrodes, such that fluid flow into or out of the first body is controlled. The fluid flow is controlled using one of the dielectrophoretic, electrophoretic or electro-osmotic effects. The invention also provides a method of controlling fluid flow, and a microfluidic switch, and microfluidic chip and a diagnostic device, wherein fluid flow is controlled in each.

### FIELD OF INVENTION

This invention relates to microfluidic components, and in particular relates to a valve for microfluidic control of fluid flow.

### BACKGROUND OF THE INVENTION

So-called “lab-on-a-chip” devices require precise microfluidic technology to regulate fluid flow through various microchannels to enhance on-chip chemical processing. Some examples of the use of this technology include improving the storage of reagents, priming of channels, switching of liquid flow-streams, as well as isolating specific areas of the chip during sensitive steps in the chemical processing, to prevent leakage and pressure fluctuations.

Research in this field is currently undertaken to develop methods of regulating miocrofluidic flow within such a chip using a series of valves. Controlling such fluid flow is essential to the efficient performance of the device.

One method of providing controlled fluid flow is to use conventional diaphragm valves. This normally involves using MEMS (micro electric mechanical systems) technology, based on silicon materials. Implementation and integration of such components, however, is complicated and very costly. Similar types of valves, such as hydrophobic passive valves, are less complicated to implement and integrate, but only provide one-way fluid flow.

Another way of providing such controlled fluid flow is to use bead-based microfluidic valves, such as that described in Ji et al. (16^{th} European Conference on Solid-State Transducers, Sep. 15-18, 2002, Prague). In this design, a number of silica micro-beads are used to block off a fluid outlet to form a check-like valve. When fluid flows through the valve from a fluid inlet in the direct of the outlet, the fluid flow causes the beads to move towards the mouth of the outlet where they aggregate. If the volume of the aggregate is large enough, then the valve effectively closes, and no more fluid flows through the outlet. As the size of the beads compared to the fluid inlet decreases, other factors such as electrostatic attraction and decreasing surface energy affect aggregation.

The disadvantage of this design is that to open the valve, the direction of fluid flow must be reversed in order to force the aggregate away from the mouth of the outlet. Furthermore, it is not possible to achieve a quick fluid flow cut-off, as in the MEMS valve described above, as it takes a finite period of time for the aggregate to achieve a sufficient volume to close off the mouth of the fluid outlet.

Simpler concepts for controlling a liquid flow are to freeze the liquid itself, use a metal ball or some form of piezo electric to create a blockage temporarily in a fluid channel. Each such solution has disadvantages such as the time log in controlling the flow—a particular problem with the solution of freezing the liquid. Bubble valves, which utilise various surface tension effects, are also known in the art. It is also known to create micrometer-sized pumps and valves by manipulating colloidal microspheres, described in Terray, Oakey and Marr, Science, vol. 296, pp 1841-1843, 2002). This uses the principle of optical trapping to manoeuvre the colloidal particles to control fluid flow.

### SUMMARY OF THE INVENTION

We have appreciated the need for a simple, reliable method and device for microfluidic fluid control. We have further appreciated that any mechanism for control of fluid should preferably have minimal impact upon the nature of the fluid itself.

We have appreciated, therefore a need to provide a microfluidic valve which provides two-way fluid flow, and which is simple to manufacture and integrate into existing systems, and which can be implemented at low cost.

Accordingly, the present invention provides a microfluidic valve comprising a first body for containing fluid having a fluid inlet and a fluid outlet and a plurality of electrodes, and arranged to contain, in use, a second body held within fluid contained in the first body, the second body being moveable toward or away from one of the fluid inlet or fluid outlet, the movement of the second body caused by a phase difference in the electric field generated by the electrodes, such that fluid flow into or out of the first body is controlled.

The invention also provides a method of controlling fluid flow in a microfluidic valve comprising: applying a voltage to a plurality of electrodes arranged on a first body containing fluid, the body having a fluid inlet and a fluid outlet thereby creating an electric field; and causing a second body to move, due to a phase difference in the electric field induced between adjacent electrodes, toward or away from one of the fluid inlet or fluid outlet.

Microfluidic chips and switches may comprise microfluidic valves in accordance with various embodiments of the invention. It is also possible to make diagnostic devices comprising such switches and chips.

Embodiments of the invention offer the advantage that fluid flow may be controlled using a simple valve, which allows two-way fluid flow into and out of a fluid containing body. This fluid control may be by means of dielectrophoresis, electrophoresis or electro-osmosis, wherein an electric field gradient or non-uniform electric field, provided by electrodes on the first body causes the second body to move.

The second body may comprise a polarisable particle of a dielectric material, such as latex, polystyrene, polypropylene, glass, silica or PTFE, or of a conductive material.

### BRIEF DESCRIPTION OF THE FIGURES

Embodiments of the invention will now be described by way of example only, and with reference to the accompanying drawings in which:

FIG. 1 is a schematic representation of and electrode arrangement to create driven particle motion due to the dielectrophoresis effect;

FIG. 2 is a schematic representation of a circuit for use in the valve device of the present invention;

FIG. 3 is a first schematic cross section of a valve in accordance with a first embodiment of the present invention;

FIG. 4 is a second schematic cross section of a valve in accordance with the first embodiment of the present invention;

FIG. 5 is a schematic representation of a second embodiment of the present invention; and

FIG. 6 is a schematic example of a third embodiment of the present invention.

### DESCRIPTION OF EMBODIMENTS OF THE INVENTION

The present embodiments of invention exploit the effect of travelling wave dielectrophoresis (TWD) to move polarisable particles within a channel to form a microfluidic valve. By way of background the phenomenon of dielectroploresis will first be described.

AC electrokinetic techniques such as dielectrophoresis and travelling wave dielectrophoresis have be used for many years in applications for the manipulation, separation and characterisation of various particles. The phenomenon occurs when a particle and surrounding medium have different polarisabilities, which in the presence of a dynamic electric field can be used to induce attractive, repulsive and travelling motion in the particle with respect to the medium.

Dielectrophoresis is exhibited by uncharged particles in non-uniform electric fields, such as those which are alternating, or which have an electric field gradient, and may be understood as being analogous to effect of electrophoresis on charged particles.

Any charged particle surrounded by a medium will attract ions of opposite charge from within that medium, forming a double layer of electric charge at the particle surface. For example, a negatively charged particle will attract positive ions. When this charged particle experiences a uniform electric field, for example, a DC electric field, this double layer becomes distorted. This is known as the Maxwell-Wagner effect. Two charges, δq+ and δq−, are induced on either side of the particle at radii r+ and r−. This produces a dipole moment of magnitude
m=(δq+)r₊−(δq−)r₋=∂q·r 1
For a spherical particle of radius r, in a medium of absolute dielectric permittivity εₘ, the magnitude of the dipole moment is

$$m = 4 π {ɛ}_{m} ( \frac{{σ}_{p}^{*} - {σ}_{m}^{*}}{{σ}_{p}^{*} + {σ}_{m}^{*}} ) {r}^{3} E \qquad 2$$

where σ*ₚ and σ*ₘ are the complex conductivities of the particle and the medium respectively.

In the case of uncharged particles, dielectrophoresis is induced when a non-uniform electric field is experienced.

The total electric force, F acting on a particle in a non-uniform electric field E is given by
F=QE+δqE(r+)−δqE(r−)=QE+(m∇)·E 3
where Q is the charge of the particle, ∇ is the vector operator Del, and other terms are as defined above.

In this situation the particle is uncharged, hence Q=0. Using the expression σ*=σ+jωε, the time-averaged force, F(ω), on the particle in the field is given by
F(ω)=2πr³εₘRe[K(ω)]∇E² 4
where K(ω) is the Clausius-Mossotti factor,

$$K ( ω ) = \frac{{ɛ}_{p}^{*} - {ɛ}_{m}^{*}}{{ɛ}_{p}^{*} + 2 {ɛ}_{m}^{*}} \qquad 5$$

ω is the is the frequency of the applied field, for example, an AC field, and Re denotes the real component of the complex Clausius-Mossitti factor respectively. This distinguishes the effect from electrophoresis.

If a polarisable particle is suspended in a rotating electric field, the induced dipole forms across the particle and rotates synchronously with the field. If the angular velocity of the field is particularly large, the relaxation time of the dipole (the time it takes to form) is significant, and the dipole will lag behind the field. A non-zero angle between the field and the dipole occurs, inducing a torque in the particle and causing it to rotate asynchronously with the field. The rotation may be with or against the direction of field, depending on whether the lag is less than or greater than 180°. This effect is known as electrorotation. The rotating electric field may be provided by a circular arrangement of electrodes, each of which is 90° out of phase with its neighbours.

The time-averaged torque, Γ, felt by a polarisable particle of radius r in a rotating electric field, E, is
Γ=−4πεₘr³Im[K(\overline{ω})]E² 6
where Im[K(\overline{ω})] is the imaginary part of the Clausius-Mossotti factor,

$$K ( ω ) = \frac{{ɛ}_{p}^{*} - {ɛ}_{m}^{*}}{{ɛ}_{p}^{*} + 2 {ɛ}_{m}^{*}} \qquad 7$$

The minus sign indicates that the dipole moment lags the field.

When viscous drag is taken into account, the rotation rate, R(\overline{ω}), of the particle is given by

$$R ( ω ) = - \frac{{ɛ}_{m} Im [ K ( ϖ ) ] {E}^{2}}{2 η} \qquad 8$$

where η is the viscosity of the medium.

Depending upon electrode geometry and the type of field applied, travelling wave dielectrophoresis, which is a combination of the effects of dielectrophoresis and electrorotation, may be induced in the particle.

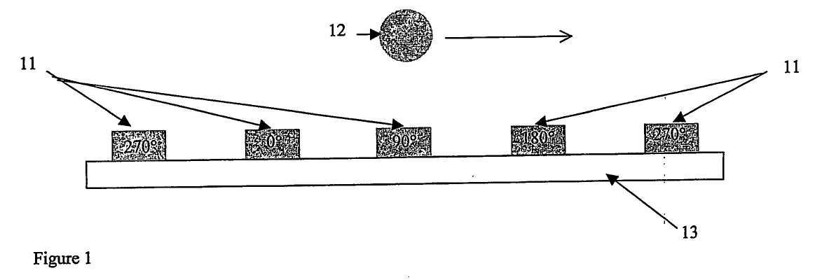

Rather than a circular arrangement, the electrodes may be arranged along a track, as shown in FIG. 1. The relationship between the electrode 11 phases remains the same, with each successive electrode 11 being 90° out of phase. Each electrode reaches a peak voltage at a different time, creating a non-uniform electric field. This results an electric field which travels along the electrodes. When this travelling wave interacts with a polarisable particle 12, a dipole is induced. This dipole moves with the electric field peak, which, if the electric field is travelling fast enough, will induce a force on the particle 12. The particle 12 then travels along the electrodes 11.

The force, F_{TWD}, induced on the particle 12 is given by

$${F}_{TWD} = \frac{- 4 π {ɛ}_{m} {r}^{3} Im [ K ( ϖ ) ] {E}^{2}}{λ} \qquad 9$$

where λ is the wavelength of the travelling wave.

Again, referring to FIG. 1, thin film electrodes 11 are formed on a glass slide 13 which is used to seal a channel for containing an analyte, for example, for use in a lab-on-a-chip system. The thin film electrodes 11 may be formed by any suitable process, for example, photolithography. The thin film electrodes are placed a distance λ apart, where λ is the wavelength of the electric field travelling wave set up by the phase difference between the current in each electrode.

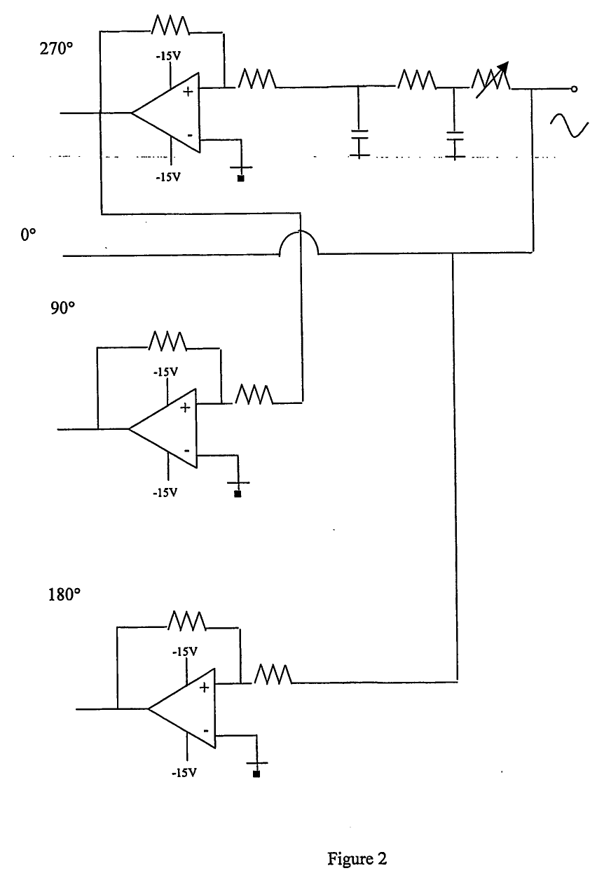

A circuit, as shown in FIG. 2, is connected to the thin film electrodes, in order to produce a travelling electric field. Each of the op-amps is connected as shown to form a negative feedback amplifier, and a 90° phase difference is induced between each electrode.

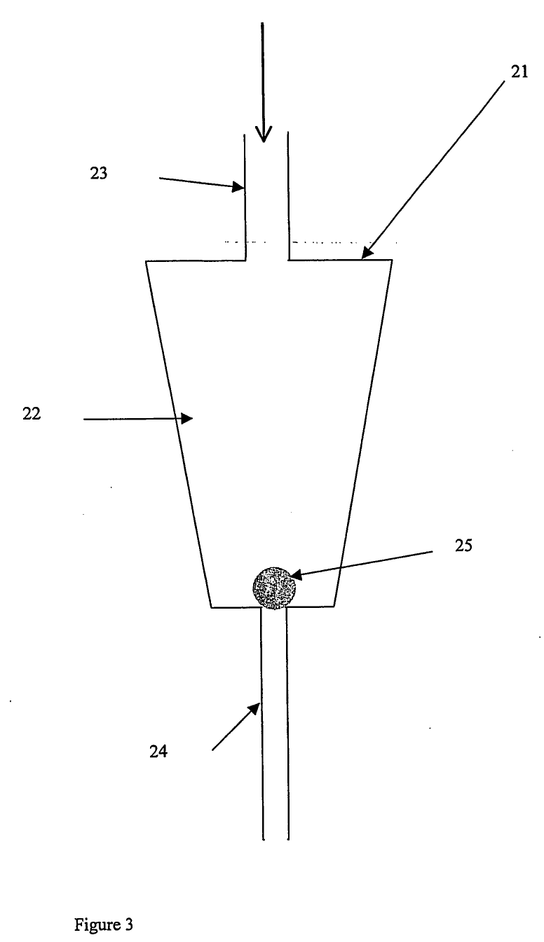

FIG. 3 shows a schematic cross-section of a valve in accordance with an embodiment of the present invention. Valve 21 comprises a first body 22 for containing fluid, a fluid inlet 23, a fluid outlet in the form of a microchannel 24 and a second body, which is a polarisable particle 25. Electrodes, not shown, are arranged along the side of the chamber 22, such that an electric field may be induced between the inlet 23 and the microchannel 24. When in use, the body contains fluid, and may be either filled or partially filled with fluid. The body may define a chamber or a channel, such as a pipe. The fluid maybe a liquid, such as a non-polar solvent, or a gas.

The particle 25 is introduced into the body 22, and fluid is free to flow into and out of the body 22 via the fluid inlet 23 and the microchannel 24. However, under the influence of this fluid flow, and gravity, the particle 25 will naturally come to rest in the mouth of the microchannel 24. As shown in FIG. 3, the body may define a chamber.

Applying AC current to the electrodes, so that the electrode at the fluid inlet 23 is 90° advanced in phase to that at the microchannel 25, (for example, when the amplitude of the AC current is positive), the dielectrophoresis effect induced in the particle 24 will force it to move towards the mouth of the microchannel 25. This prevents fluid flow through the body 22. If the direction of the electric field is changed, for example, by inducing a 90° phase lag in the electrode at the inlet 23 with respect to that at the microchannel 24, (for example, when the amplitude of the AC current is negative) then the particle will be forced away from the mouth of the microchannel 24, allowing fluid flow to resume. When the particle 25 rests in the mouth of the microchannel 24, the valve is switched off. When the particle 25 moves away from the microchannel, the valve is switched on.

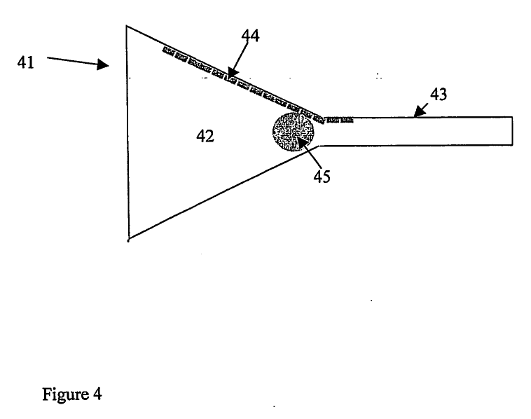

FIG. 4 shows a second schematic cross section of a valve in accordance with the first embodiment of the present invention. The valve 41 comprises a first body 42 for containing fluid, which in this embodiment is a chamber, and a microchannel 43. A number of electrodes 44 are placed on one side of the fluid chamber 42. It would of course be possible to place a number of electrodes on opposite or adjacent sides of the body. A second body, the polarisable particle 45, is placed within the fluid chamber 42. The electrodes 44 may be connected to a circuit to provide a travelling AC field, such as that shown in FIG. 2, or any other suitable circuit. Again, inducing 90° phase advance in the electrodes 44 away from the microchannel 43 will cause the polarisable particle 45 to move towards the mouth of the microchannel 43, whilst inducing a phase lag will cause the polarisable particle 45 to move away from the mouth of the microchannel 43. In this manner, fluid flow can be controlled similarly to in the valve of FIG. 3. In this embodiment, the polarisable particle is of a dielectric material, such as a latex, polystyrene, polypropylene, glass or silica bead, or other such materials of a suitable density. Although in the present embodiment, the particle is spherical, it may also be non-spherical, for example obloid, with the long axis arrange parallel to the electric field direction. Such a particle may then be used to regulate fluid flow, by regulating the electric field frequency (to avoid electrorotation effects) such that the fluid inlet or fluid outlet is closed off slowly, resulting in a gradually decreasing or increasing flow of fluid. Alternatively, the particle may be spherical, but formed of a deformable or resilient material, for example, rubber or PTFE.

The body for containing fluid may be of an insulating material, for example, a plastic (thermosetting or thermoplastic) or glass with metallic electrodes applied to the outside using conventional forming methods. The electrodes do not have to be formed on an outer surface of the body, but merely in a position where the electric filed generated affects the polarisable particle held within the body. Alternatively, the body itself could be metallic, with an insulating coating, and electrodes applied such that an electric field is set up in regions coated with the insulator.

The valve may alternatively be set up such that phase lag causes the polarisable particle 42 to move toward the mouth of the microchannel 43.

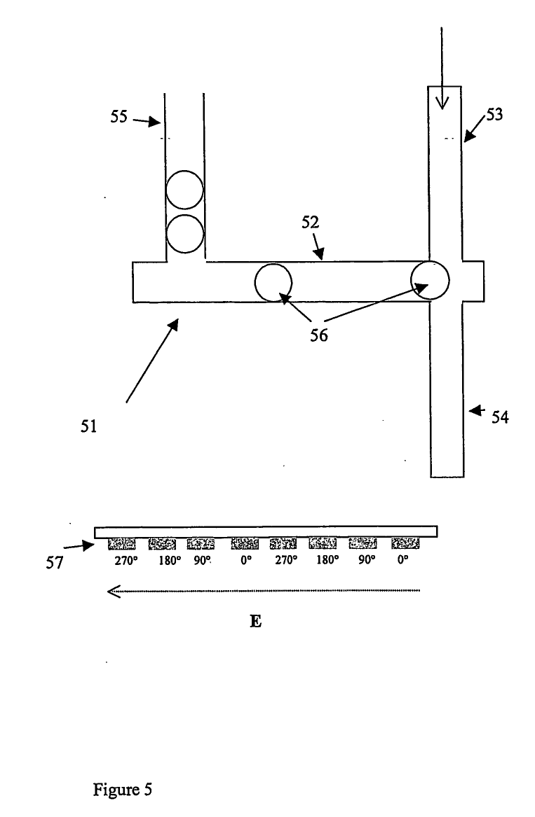

FIG. 5 shows a valve in accordance with a second embodiment of the present invention. The valve 51 comprises a first body 52 for containing fluid, a fluid inlet 53, a fluid outlet 54, a particle injection channel 55 and a plurality of second bodies, such as the polarisable particles 56. An electrode array 57 is shown for illustrative purposes only. In this embodiment, the body defines a channel, and may be a pipe, for example.

Polarisable particles 56 are injected into the fluid chamber 52 via particle injection channel 55. AC current is applied to the electrode array 57, inducing a travelling electric field. In the configuration shown, each electrode experiences an applied signal which is 90° phase lagged with respect to the electrode on the left—that nearest the particle injection channel—then an electric field is set up with a travelling wave moving away from the fluid inlet 53 and fluid outlet 54. This causes a polarisable particle 56, for example a latex bead, which was blocking the fluid outlet 54 to be forced away from the mouth of the outlet 54, allowing fluid to flow.

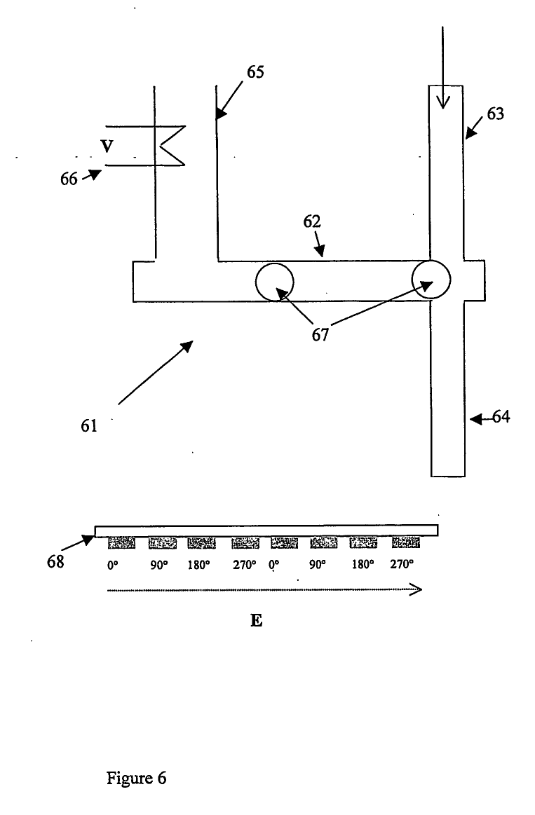

FIG. 6 shows a valve in accordance with a third embodiment of the present invention. A valve 61 comprises a first body 62 for containing fluid, a fluid inlet 63, a fluid outlet 64, a bubble generation chamber 65 and associated electrode 66 and bubbles 67. Again, an array of electrodes 68 is shown for illustrative purposes only, and the body defines a channel.

Bubbles 66 are created in the bubble generation chamber 65 by applying a voltage V across electrode 66.

These are injected into the body 52 from the bubble generation chamber 65. AC current is applied to the electrode array 68, inducing a travelling electric field. In the configuration shown, each electrode experiences an applied signal which is 90° phase advanced with respect to the electrode on the left—that nearest the particle injection channel—then an electric field is set up with a travelling wave moving towards the fluid inlet 63 and fluid outlet 64. This causes a bubble 66 to move towards the mouth of the fluid outlet 64, acting to block the fluid outlet 64. This closes the valve and prevents fluid flow.

Bubbles may alternatively be held in a reservoir until needed, or created by bubbling an inert gas such as argon through the generation chamber. Where the fluid in the valve is a liquid, it is possible to use a liquid-filled bubble in preference to a gas-filled bubble. The liquid used to fill the bubble would need to conform to certain physical criteria with regard to viscosity, surface tension and density. One example of this would be the use of an oil drop bubble in an aqueous liquid.

In both valves shown in FIGS. 5 and 6, when the phase lag or advanced is reversed, the direction of the electric field travelling wave is reversed, and the polarisable particle or bubble moved towards or away from the fluid outlet.

In effect, the polarisable particles or bubbles act as pistons, moving towards and away from the valve seat the mount of the fluid outlet, to regulate fluid flow. Fluid flow in this situation is microfluidic flow, which is laminar. The force on the particle determines the speed of the particle, and consequently the rate at which the valve can be opened or closed. In this manner, the valve may be used as a microfluidic switch, switching fluid flow on and off in lab-on-a-chip applications. The valve may also be included in a microfluidic chip. Various diagnostic devices may comprise such chips and switches.

Although the invention has been described with reference to the effect of travelling wave dielectrophoresis it will of course be apparent to one skilled in the art that it is possible to use a polarisable particle formed of an electrically conductive material rather than one of a dielectric material, and to utilise the effect of electrophoresis, described above, to produce a travelling wave which moves such a particle toward or away from fluid inlet or outlet. This is of particular use if the valve is used for inorganic chemical processing. Furthermore, it would be possible to utilise an electrophoretic valve with various charged chemicals, for example, DNA. Electrodes may be arranged on the first body to cause the DNA to agglomerate, thus forming a self-regulating valve without the need for an additional second body such as a polarisable particle.

The second body may also be used to control fluid flow into and out of the microfluidic valve by means of the electro-osmotic effect.

When a voltage is applied across the two ends of a fluid-filled body or channel, positive ions of the fluid will be attracted to the walls of the body or channel. These positive ions will then move under the influence of the electric field created by applying the voltage. Fluid will be dragged along the body or channel by the positive ions due to viscous coupling.

The velocity of the fluid, v_{EOF}, is governed by the equation:

$${ν}_{EOF} = \frac{{ɛ}_{0} {ɛ}_{r} ζ}{η} {E}^{->} = {μ}_{EO} {E}^{->} \qquad 10$$

where μ₀ is the permittivity of a vacuum, μᵣ is the relative permittivity of the fluid, ξ is the zeta potential, η is the viscosity of the fluid and μ_{EO} the electro-osmotic mobility.

Consequently, it would be possible to produce a valve where the second body may be in fact a second type of fluid, or where the second body is carried along by the fluid, rather than by the direct influence of the electric field, as with the electrophoresis and dielectrophoresis effects.

Whilst the invention has been described with respect to moving the particle toward a fluid outlet, it is of course possible to form a valve where the fluid flow through the inlet is switched on and off, depending upon the application the valve will be used for.

Furthermore, the embodiments described herein have comprised a single fluid inlet and a single fluid outlet. However, it is also possible that valves with a plurality of inlets or outlets or both, could be used. In this case, with suitable arrangement of electrodes with respect to each inlet and outlet, the flow of fluid through each inlet and/or outlet could be controlled.

Although various embodiments of the invention have been described in relation to a fluid-filled body which is in the form of either a chamber or a channel. When a channel is used, the size of the polarisable particle must be restricted such that it will move freely through the channel. Typically, the channel width is 50 to 100 μm. A second restriction is that the particle must have a large enough diameter to be affected by the electric field caused by two electrodes. For example, if the electrodes are 10 μm in length, and each spaced apart by 10 μm, then the smallest possible diameter of the particle is also 10 μm.

This in turn causes a restriction on the width of the fluid inlet and fluid outlet, which must both have a width comparable to the diameter of the particle, in order for the fluid flow to be controlled effectively.

Various other modifications are possible and will occur to those skilled in the art without departing from the scope of the invention which is defined by the appended claims.

1. A microfluidic valve comprising a first body for containing fluid having a fluid inlet and a fluid outlet and a plurality of electrodes, and arranged to contain, in use, a second body held within fluid contained in the first body, the second body being moveable toward or away from one of the fluid inlet or fluid outlet, the movement of the second body caused by a phase difference in the electric field generated by the electrodes, such that fluid flow into or out of the first body is controlled.

2. The microfluidic valve of claim 1, wherein the plurality of electrodes is an array.

3. The microfluidic valve of claim 1, wherein the plurality of electrodes are arranged on a side of the first body.

4. The microfluidic valve of claim 1, wherein the plurality of electrodes are arranged on opposite sides of the first body.

5. The microfluidic valve of claim 1, wherein the plurality of electrodes are arranged on adjacent sides of the first body.

6. The microfluidic valve of claim 1, wherein the phase difference is produced by an electric field gradient created by applying alternating current to the plurality of electrodes.

7. The microfluidic valve of claim 1, wherein the phase difference is produced by a non-uniform electric field created by applying alternating current to the plurality of electrodes.

8. The microfluidic valve of claim 6, wherein the phase difference is a phase lag of 90°.

9. The microfluidic valve of claim 7, wherein the phase difference is a phase lag of 90°.

10. The microfluidic valve of claim 1, wherein the phase difference causes the second body to move toward or away from one of the fluid inlet or fluid outlet.

11. The microfluidic valve of claim 1, wherein when the second body is moved toward one of the fluid inlet or fluid outlet, fluid flow into or out of the body is precented.

12. The mircofludic valve of claim 11, wherein when fluid flow is prevented, the valve is switched off.

13. The microfluidic valve of claim 10, wherein when the second body if moved away from one of the fluid inlet or fluid outlet, the valve is on.

14. The microfluidic valve of claim 1, wherein the second body is of a dielectric material.

15. The microfluidic valve of claim 14, wherein the dielectric material is one of latex, polystyrene, polypropylene, glass, silica or PTFE.

16. The microfluidic valve of claim 1, wherein the second body is a bubble.

17. The microfluidic valve of claim 16, further comprising a bubble generation chamber with an opening into the body.

18. The microfluidic valve of any claim 1, wherein the first body defines a chamber.

19. The microfluidic body of any of claim 1, wherein the first body defines a channel.

20. The microfluidic valve of claim 19, wherein the channel is a pipe.

21. The microfluidic valve claim 1, wherein the second body is moveable in the electric field by dielectrophoresis.

22. The microfluidic valve of claim 1, wherein the second body is electrically conductive.

23. The microfluidic valve of claim 22, wherein the second body is moveable in the electric field by electrophoresis.

24. The microfluidic valve of claim 1, wherein the second body is moveable in the electric field by electro-osmosis.

25. The microfluidic valve of claim 1, wherein the fluid flow is laminar.

26. The microfluidic valve of claim 1, wherein the first body has a plurality of inlets.

27. The microfluidic valve of any of claim 1, wherein the first body has a plurality of outlets.

28. The microfluidic valve of claim 26, wherein the fluid flow through each inlet or each outlet is controllable.

29. The microfluidic valve of claim 1, wherein the second body controls fluid flow through a fluid inlet.

30. The microfluidic valve of any of claim 1, wherein the second body controls fluid flow through a fluid outlet.

31. The microfluidic valve of claim 1, wherein the fluid is a liquid.

32. The microfluidic valve of any of claim 1, wherein the fluid is a gas.

33. A method of controlling fluid flow is a microfluidic valve comprising:
applying a voltage to a plurality of electrodes arranged on a first body containing fluid, the body having a fluid inlet and a fluid outlet thereby creating an electric field; and
causing a second body to move, due to a phase difference in the electric field induced between adjacent electrodes, toward or away from one of the fluid inlet or fluid outlet.

34. The method of claim 33, wherein the plurality of electrodes is an array.

35. The method of claim 33, wherein an alternating current is applied to the electrodes.

36. The method of claim 33, wherein the phase difference is a phase lag of 90°.

37. The method of any of claim 33, wherein the phase difference is a phase advance of 90°.

38. The method of claim 33, wherein the phase difference causes the second body to move toward or away from one of the fluid inlet or fluid outlet.

39. The method of claim 38, wherein when the second body is moved toward one of the fluid inlet or fluid outlet, fluid flow into or out of the first body is prevented.

40. The method of claim 39, wherein when fluid flow is prevented, the valve is switched off.

41. The method of claim 33, wherein when the second body is moved away from one of the fluid inlet or fluid outlet, the valve is switched on.

42. The method of claim 33, wherein the second body is of a dielectric material.

43. The method of claim 42, wherein the dielectric material is one of latex, polystyrene, polypropylene, glass, silica of PTFE.

44. The method of claim 33, wherein the second body is a bubble.

45. The method of claim 44, further comprising generating the bubble in a bubble generation chamber which opens onto the first body.

46. The method of claim 45, further comprising introducing the bubble into the first body.

47. The method of claim 46, wherein the bubble is introduced into the first body before applying alternating current to the plurality of electrodes.

48. The method of claim 46, wherein the bubble is introduced into the first body after applying alternating current to the plurality of electrodes.

49. The method of claim 33 to 48, wherein the second body is moveable in the electric field by 30 dielectrophoresis.

50. The method of claim 33, wherein the second body is an electrically conductive particle.

51. The method of claim 50, wherein the second body is moveable in the electric field by electrophoresis.

52. The method of any of claim 33, wherein the second body is moveable in the electric field by electro-osmosis.

53. A microfluidic chip comprising the microfluidic valve of claim 1.

54. A microfluidic switch comprising the valve of claim 1.

55. The method of claim 33, wherein the electric field is non-uniform.

56. The method of claim 33, wherein the electric field has an electric field gradient.

57. A diagnostic device comprising the microfluidic valve of claim 1.

58. A microfluidic valve substantially as herein described and with reference to FIGS. 2 to 6 of the accompanying drawings.

59. A method of controlling fluid flow substantially as described herein and with reference to FIGS. 2 to 6 of the accompanying drawings.

60. A diagnostic device comprising the microfluidic switch of claim 55.
